(19) United States
(12) Patent Application Publication
(10) Pub. No.: US 2020/0404359 A1
(43) Pub. Date: Dec. 24, 2020

(54) VIDEO AGGREGATING, PEER DETERMINATION, PEER-REVIEW AND QUALITY VIDEO PROGRAMMING AND SOCIAL MEDIA METHOD FOR PERFORMING ARTISTS, VISUAL ARTISTS, ATHLETES ON WEBSITES AND MOBILE DEVICES

(71) Applicant: Alan Neil Boinus, Languna Beach (CA)

(72) Inventor: Alan Neil Boinus, Languna Beach (CA)

(21) Appl. No.: 16/108,047

(22) Filed: Aug. 21, 2018

Related U.S. Application Data
(60) Provisional application No. 62/547,883, filed on Aug. 21, 2017.

(51) Int. Cl. H04N 21/437; G06Q 50/00

(52) U.S. Cl. CPC H04N 21/437; G06Q 50/01

(57) ABSTRACT

Disclosed herein is a novel application for aggregating and quantifying quality performing artists,' writing artists,' visual artists,' and athletes' video recordings uploaded on the Internet based on a novel peer determination method, novel peer review method and novel method for ranking quality peer review video recordings for programming and streaming to Internet viewer channels on web-based applications, mobile phones and mobile computer devices or non-Internet broadcasting and novel social media methods.

### BACKGROUND OF THE INVENTION

### A. Understanding the Invention

The present invention presents a novel and enhanced video programming application for both Internet and mobile phones in which a novel and enhanced method is used for determining quality video recordings of performance artists, visual artists, writing artists and athletes based on a selection method for determining peer reviewers of video recordings on the Internet and/or mobile phone and mobile computer devices of performance artists, visual artists, writing artists and athletes. These video recordings are ranked and automated for programming and streaming based on reviews of video recordings by peer reviewers on the Internet and/or mobile phone and mobile computer devices. The links of quality video recordings based on ranking of reviews by peer reviewers are shared to social networks via web-based applications on the Internet and/or mobile phone and mobile computer devices.

### B. Field of the Invention

The present invention is a web-based program for Internet or mobile devices for delivering quality performing artists,' visual artists,' writing artists' and athletes' video recordings on the Internet or non-Internet broadcast or streaming channels and social media methods.

Under the present invention, a computer system may be comprised of a dynamic process for a customizable computational engine that aggregates and sorts video recording uploaded to the Internet according to a video uploader user's background, education, training, experience and field of expertise input and uploaded to a website application on the Internet and compares and matches said data with data stored about the website's composite users' background, education, training, experience, field of expertise and professional affiliations stored on a computer server for peer reviewing purposes and randomly routes said video recordings to a corresponding website user for peer reviewing according to best matching according to peer reviewer standards programmed in a computer system.

Under the present invention, a computer system is programmed with a knowledge base of quality reviewing reference information for various computational components of the invention.

Under the present invention, peer reviewer users view and playback video recordings and input feedback, critiques, reviews or input numerical values corresponding to programmable quality standards for videotape recordings.

Under the present invention, an empirical feedback system of reviews of video recordings by peer reviewers are input into a computer system and quantified according to dynamic ranking routes and streams said video recordings to programming channels for viewing and playback on the Internet.

Under the present invention, video recording programming that may be accessed in archives or may be shared via distributed social networks.

### BRIEF SUMMARY OF THE INVENTION

The present invention programs quality performing artists' videos and visual artists' videos for streaming and broadcasting on the Internet and mobile phones that the system ranks based on quality criteria as determined by peer reviewers that the system determines according to background, education, training, experience, field of expertise and professional affiliations in the field of performing arts, visual arts, writing arts, sports or athletics.

### BRIEF DESCRIPTION OF THE DRAWINGS

FIG. 1 depicts a flow chart of the navigation of the software technology and its processes for Claims 1 and 2.

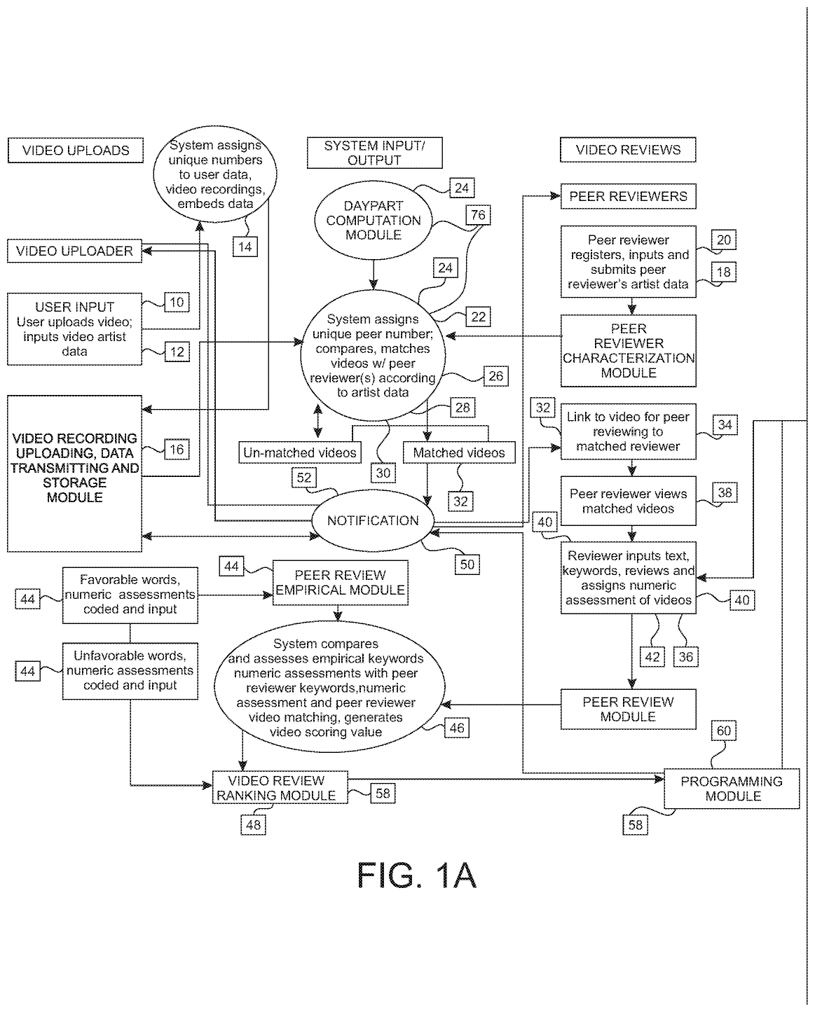

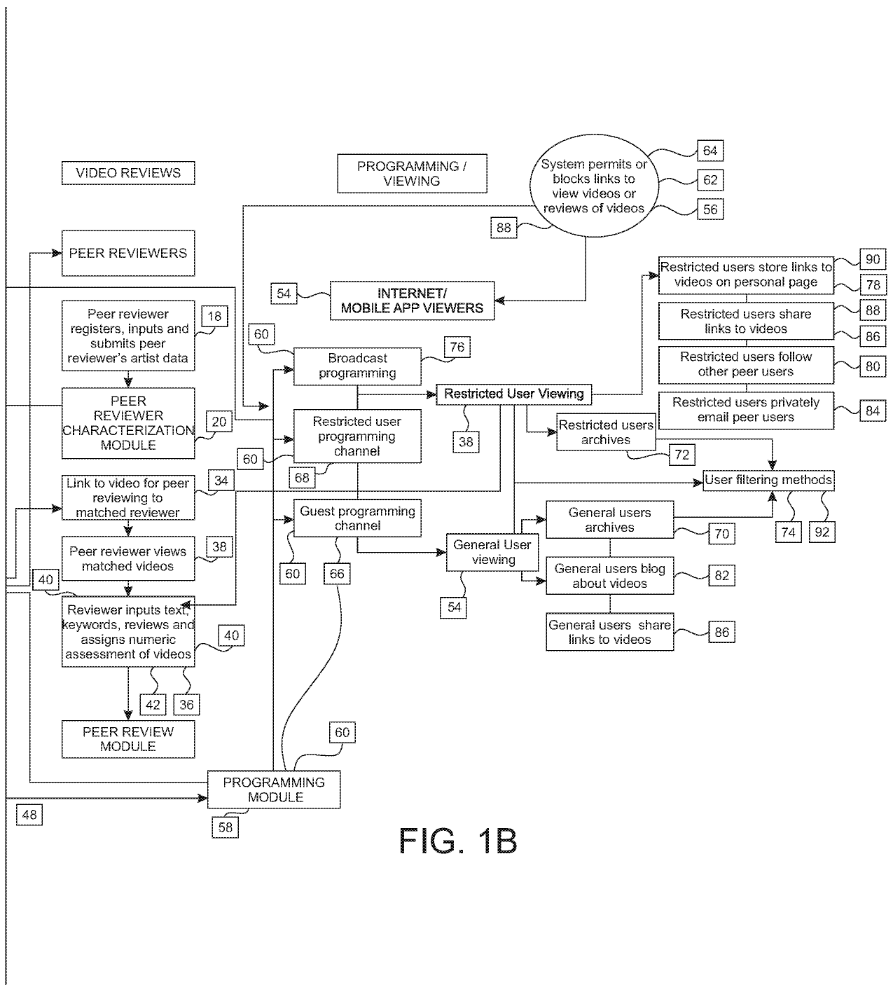

### DETAILED DESCRIPTION OF THE DRAWINGS

| FIG. | EL# | EMBODIMENT DESCRIPTIONS |
|---|---|---|
| | | VIDEO UPLOADER USER |
| 1A | 10 | In one embodiment of the present invention, users input video |
| | | recordings into a web application stored on a computer server. |
| 1A | 12 | In one embodiment of the present invention, users input user |
| | | data and data about performance, visual arts, writing arts, |
| | | athletic arts as it corresponds to user video recordings uploaded |
| | | into a web application stored on a computer server. |
| 1A | 14 | In one embodiment of the present invention, a computer system |
| | | assigns a unique number to user video recordings and assigns |
| | | corresponding unique number to performance, visual arts, |
| | | writing arts, athletic arts data corresponding to said video |
| | | generating a data file with code referencing said unique number |
| | | for comparison, matching and retrieval of data records. |
| 1A | 16 | In one embodiment of the present invention, the system stores |
| | | digital unique number coded data files for comparison, |
| | | matching and retrieval of data records of video recordings |
| | | digitalized for Internet, mobile phone and mobile computer |
| | | devices for upload and playback with data records of performance, |
| | | visual arts, writing arts, athletic arts of corresponding to said |
| | | video recordings. |
| | | PEER REVIEWER USER |
| 1A | 18 | In one embodiment of the present invention, Internet or mobile |
| 1B | | phone users register in a web-based application to be a video |
| | | peer reviewer and input personal information about their |
| | | respective performing arts, visual arts, writing arts or athletic |
| | | arts, training or field of expertise into a web-based application |
| | | for Internet or mobile phones. |
| 1A | 20 | In one embodiment of the present invention, video peer |
| 1B | | reviewer user information about their respective performance, |
| | | performing arts, visual arts, writing arts or athletic arts or field |
| | | of expertise is input in a web-based application for Internet, |
| | | mobile phones or mobile computer devices and is stored |
| | | digitally on a computer server. |
| 1A | 22 | In one embodiment of the present invention, a computer system |
| | | assigns a unique number to peer-reviewers generating a data file |
| | | with code referencing said unique number for comparison, |
| | | matching and retrieval of data records. |
| 1A | 24 | In one embodiment of the present invention, a computer system |
| | | is programmed to process uploaded video recordings for peer |
| | | review and programming at designated day and timeslots. |
| 1A | 26 | In one embodiment of the present invention, a computer system |
| | | compares and matches data files of performance arts, visual |
| | | arts, writing arts or athletic arts data files corresponding to |
| | | video recordings digitalized for Internet and mobile phone |
| | | upload and computer mobile device playback with data files of |
| | | video peer reviewers by performance, visual arts, writing arts or |
| | | athletic arts category. |
| 1A | 28 | In one embodiment of the present invention, the system is |
| | | programmed to make uniform distributions of matched |
| | | performance arts, visual arts, writing arts or athletic arts data |
| | | files corresponding to video recordings digitalized for Internet |
| | | and mobile phone upload and computer mobile device playback |
| | | with data files of video peer reviewers by performance, visual |
| | | arts, writing arts or athletic arts category. |
| 1A | 30 | In one embodiment of the present invention, a computer system |
| | | assigns a priority categorization to unreviewed and unmatched |
| | | video recordings or proportionally under-reviewed and |
| | | unmatched video recordings based on unsuccessful attempts to |
| | | match unreviewed or under-reviewed video recordings for |
| | | programming purposes to video peer reviewers. |
| 1A | 32 | In one embodiment of the present invention, a computer system |
| | | distributes links to video recordings that are matched with video |
| | | peer reviewers according to performance arts, visual arts, |
| | | writing arts or athletic arts of respective video peer reviewers |
| | | via attachments to email, text messaging, Internet mailboxes or |
| | | other means of contacting the respective video peer reviewer for |
| | | purposes of reviewing said matched video recordings. |
| 1A | 34 | In one embodiment of the present invention, video recording |
| 1B | | peer reviewers link to peer matched video recordings distributed |
| | | to them by the system to view said peer matched video |
| | | recordings. |
| 1A | 36 | In one embodiment of the present invention, video recording |
| 1B | | peer reviewers input text, keywords, commentary, reviews, tags |
| | | and numeric assessments of video recordings whose links for |
| | | viewing and reviewing are distributed to them by the system. |
| 1A | 38 | In one embodiment of the present invention, peer reviewers |
| 1B | | view video recordings of video recordings programmed by the |
| | | system for viewing. |
| 1A | 40 | In one embodiment of the present invention, video recording |
| 1B | | peer reviewers input text, keywords, commentary, reviews, tags |
| | | and numeric assessments of video recordings programmed by |
| | | the system for viewing. |
| 1A | 42 | In one embodiment of the present invention, video recording |
| 1B | | peer reviewers submit text, keywords, commentary, reviews, |
| | | tags and numeric assessments of video recordings reviewed by |
| | | said peer reviewers to a computer system for ranking and |
| | | programming purposes. |
| 1A | 44 | In one embodiment of the present invention, keywords and |
| | | numeric data is empirically coded as favorable or unfavorable |
| | | and stored in a database on a computer server. |
| 1A | 46 | In one embodiment of the present invention, a computer system |
| | | dynamically compares and matches favorable and unfavorable |
| | | keywords in video recording reviews provided by video peer |
| | | reviewers with empirical database of favorable and unfavorable |
| | | keywords stored on a computer server and generates a scoring |
| | | of video recordings according to a programmed algorithm of |
| | | most favorable to least favorable for purposes of programming |
| | | said video recordings for viewing or peer reviewing. |
| 1A | 48 | In one embodiment of the present invention, the system |
| 1B | | dynamically programs video recordings for streaming to |
| | | viewing on Internet channels viewed on web applications, |
| | | mobile phone or mobile computer devices based on ranking of |
| | | most favorable to least favorable scoring of peer-reviewed video |
| | | recordings. |
| 1A | 50 | In one embodiment of the present invention, a computer system |
| | | notifies and transmits peer reviewer's peer reviews to the video |
| | | uploader via email, text messaging, Internet mailboxes or other |
| | | means. |
| 1A | 52 | In one embodiment of the present invention, the system notifies |
| | | and transmits programming information to the video uploader |
| | | via email, text messaging, Internet mailboxes or other means. |
| | | VIEWER USERS |
| 1B | 54 | In one embodiment of the present invention, Internet users, |
| | | mobile phone users or mobile computer devices users view |
| | | video recordings on a web-based application. |
| 1B | 56 | In one embodiment of the present invention, a system permits or |
| | | blocks Internet users, mobile phone users or mobile computer |
| | | devices users to view video recordings on a web-based |
| | | application for purpose of peer reviewing. |
| 1A | 58 | In one embodiment of the present invention, the system stores |
| 1B | | links corresponding to a video recordings and dynamically |
| | | adjusts ranking in a programming viewing module according to |
| | | composite favorability scores of video recordings. |
| 1A | 60 | In one embodiment of the present invention, video recordings |
| 1B | | are streamed to programming channels on a website based |
| | | application according to a video recording's composite |
| | | favorability ranking according to performance arts, visual arts, |
| | | writing arts or athletic arts for viewership by Internet users on |
| | | the Internet, mobile phones or mobile computer devices. |
| 1B | 62 | In one embodiment of the present invention, the system permits |
| | | or restricts viewer views of videotape recordings in viewer |
| | | channels accessed through a website application according to |
| | | dynamic favorability ranking of said video recordings. |
| 1B | 64 | In one embodiment of the present invention, a computer system |
| | | automates programming of unreviewed video recordings into a |
| | | programming queue for main screen viewing by restricted |
| | | Internet, mobile phone and mobile computer device viewing audiences. |
| 1B | 66 | In one embodiment of the present invention, a computer system |
| | | automates programming of video recordings ranked as most |
| | | favorable into a programming queue for viewing by unrestricted |
| | | Internet, mobile phone and mobile computer device viewing |
| | | audiences. |
| 1B | 68 | In one embodiment of the present invention, a computer system |
| | | automates programming of video recordings reviewed as least |
| | | favorable into a programming queue for unrestricted viewing by |
| | | restricted Internet, mobile phone and mobile computer device |
| | | viewing or peer reviewing audiences. |
| 1B | 70 | In one embodiment of the present invention, links to video |
| | | recordings programmed for general Internet or mobile phone |
| | | viewing audiences are stored in an archives accessible by |
| | | unrestricted viewing audiences. |
| 1B | 72 | In one embodiment of the present invention, links to video |
| | | recordings programmed for restricted viewing audiences are |
| | | stored in an archives accessible by restricted viewing audiences. |
| 1B | 74 | In one embodiment of the present invention, viewing of |
| | | videotape recordings may be searched, filtered and sorted by the |
| | | user according to user searching, filtering and sorting |
| | | preference, such as time zone, keywords, performance arts, |
| | | visual arts, writing arts or athletic arts, performance artist's, |
| | | visual artist's, writer's or athlete's name, school or training, |
| | | professional experience, professional guild or union membership, |
| | | for access via web browsers, mobile phones or mobile computer devices. |
| 1A | 76 | In one embodiment of the present invention, a computer system |
| 1B | | dynamically automates programming of video recordings for |
| | | peer reviewing or for viewing based on programmed day time |
| | | schedule and algorithm that determines video recording quality |
| | | ranking based on cumulative video scoring of said video |
| | | recordings at the respective day time schedule. |
| 1B | 78 | In one embodiment of the present invention, users may maintain |
| | | their own page and store and retrieve system permitted links to |
| | | video recordings stored by the system. |
| 1B | 80 | In one embodiment of the present invention, users of a video |
| | | uploading and reviewing program may follow other users of the |
| | | respective program. |
| 1B | 82 | In one embodiment of the present invention, users of a video uploading |
| | | and reviewing program may blog about user video recordings. |
| 1B | 84 | In one embodiment of the present invention, users of a video |
| | | uploading and reviewing program may privately contact performers |
| | | based on user contact preferences. |
| 1B | 86 | In one embodiment of the present invention, users of a video |
| | | uploading and reviewing program share links of video recordings |
| | | to user social networks. |
| 1B | 88 | In one embodiment of the present invention, the system permits |
| | | or blocks user links of video recordings to user social networks. |
| 1B | 90 | In one embodiment of the present invention, users store and |
| | | retrieve links to their personal uploaded video recordings for |
| | | viewing, storing, sharing or retrieving links for viewing, storing |
| | | or sharing video recordings of other preferred users. |
| 1B | 92 | In one embodiment of the present invention, all artist videos |
| | | may be accessed via search, filter and sort features of an |
| | | archive. |

### 6. DISTINGUISHING THE INVENTION FROM OTHER INVENTIONS

The current state of the art is Internet applications and mobile phone applications of infinite video recordings that may be reviewed, commented on and blogged about, without regard to video reviewer, commenter, blogger users' background, education, training, experience, field of expertise and professional affiliations in the field of performing arts, visual arts, writing arts, sports or athletics. The present invention implements a system for reviewing, commenting and blogging with regard to video reviewer, commenter, blogger users' background, education, training, experience, field of expertise and professional affiliations in the field of performing arts, visual arts, writing arts, sports or athletics.

The current state of the art is Internet applications and mobile phone applications of infinite video recordings that may be reviewed, commented on and blogged about, but are not peer reviewed for programming purposes. The present invention implements a system for peer reviewing videos for programming purposes.

The current state of the art is an Internet applications and mobile phone applications of infinite video recordings that are accessible by infinite users that may be ranked by popularity without regard to quality of programming content. The present invention implements a system that ranks videos according to quality of programming content.

The current state of the art is Internet applications and mobile phone applications of infinite video recordings that are accessible by infinite users without regard to video uploader users' background, education, training, experience, field of expertise and professional affiliations in the field of performing arts, visual arts, writing arts, sports or athletics. The present invention implements a system with regard to video uploader users' background, education, training, experience, field of expertise and professional affiliations in the field of performing arts, visual arts, writing arts, sports or athletes.

The invention claimed is:

1. The system of claim 1, comprising a computer system configured to receive from user's terminal uploads of digital video recordings to a video recording uploading, data transmitting and storage module resident on a system server comprising of at least of one server configured to receive, store and transmit digital video recording data from video recording uploader user's terminal.

2. The system of claim 1, comprising a computer system configured to receive from user's terminal data corresponding to uploaded video recordings comprising of data of user educational experience, professional training experience and performing arts, visual arts, writing arts and athletic expertise and email address transmitted to a video recording uploading, data transmitting and storage module resident on a system server configured to receive and transmit such data to a peer reviewing characterization module.

3. The system of claim 1, comprising a computer system resident on a system server comprising of at least of one computational module configured to (a) encode unique numbers to videotape recordings stored in a video recording uploading and storage module resident on a system server; (b) encode corresponding unique numbers to videotape recording data files; and (c) encode code to videotape recording data files stored in a video recording data uploading and storage module resident on a system server capable of receiving, transmitting data and communicating with corresponding video tape recordings stored in a video recording uploading and storage module resident on a system server.

4. The system of claim 1, comprising a computer system configured with a video recording peer reviewer characterization module resident on a system server comprising of at least one server configured to receive from video peer reviewer-user's terminal data concerning video peer reviewer's characterization including user input of user educational experience, professional training experience and performance arts, visual arts, writing and athletic expertise and email address configured to receive, store and transmit said data; and comprising of at least of one computational module resident on a system server configured to encode unique numbers to
peer reviewer characterization data files capable of receiving, communicating and transmitting data.

5. The system of claim 1, comprising a computer system configured with a computational
module resident on a system server configured to access, analyze, sort and randomly match data files stored on a video recording characterization module resident on a system server with randomly accessed data stored in data files on a peer-reviewing characterization module resident on a system server and generating an output data file of single matched peer reviewer data with video recording characterization data and transmitted to a video recording for review assignment module resident on a system server capable of receiving and transmitting such data.

6. The system of claim 1, comprising a video recording for review assignment module and computer system programmed to dynamically transmit email notifications to peer reviewers whose email data and corresponding video recording for review data is stored on a peer-reviewing characterization module resident on a system server with links to corresponding videotape recordings stored in video recording uploading, data transmitting and storage module resident on a system server.

7. The system of claim 2, comprising a computer system in which peer-reviewers who link to video recordings stored in a video recording uploading and storage module resident on a system server provided in email sent by a system server view and playback video recordings on Internet web-based application, mobile phone and tablet computers devices and input feedback, critiques, reviews, tags, numeric assignments corresponding to least favorable to most favorable transmit said peer review data to peer-review review module resident on a system server capable of receiving and transmitting such data.

8. The system of claim 2, comprising a customizable computational engine that stores keywords and numeric values programmed to correspond to least favorable to most favorable keywords and most favorable to least favorable numeric values in a peerreview empirical module resident on a system server capable of receiving and transmitting such data.

9. The system of claim 2, comprising a computer system comprising a customizable computational engine that (a) compares, assesses and matches peer review keyword and numeric values of feedback, critiques, reviews, tags, numeric assignments corresponding to most favorable to least favorable stored in a peer-review review module resident on on a system server to most favorable to least favorable keywords and most favorable to least favorable numeric values stored in a peer-review empirical module resident on a system server and (b) a computer system comprising a customizable computational engine that generates a scoring value of most favorable to least favorable video recording based on most favorable to least favorable peer reviews and (c) a computer system comprising a customizable computational engine that generates a ranking of most favorable video recording to least favorable video recording according to video recording scoring values and transmits said ranking associated with said video recordings to a peer-review programming module resident on a system server capable of receiving and transmitting such data and (d) a computer system comprising a customizable computational engine that dynamically implements the compare, matching, scoring value and ranking process according to day and time schedule in a daypart review module resident on a computer server capable of receiving and transmitting such data.

10. The system of claim 2, comprising a computer system that dynamically ranks video recordings according to most favorable to least favorable peer review video scoring value for said video recordings stored in a peer-review programming module resident on a system server capable of transmitting links to said video recordings for viewing and peer reviewing purposes to viewer channels of a web-based application or to archives of a web-based application.

11. The system of claim 2, comprising a computer system comprising a computational system resident on a system server programmed to permit or block access to user viewing, playback, reviewing, sharing of links of videotape recordings stored in a video recording uploading, data transmitting and storage module resident on a system server based on system criteria for access, playback and viewership of videotape recordings as programmed by said computer system for respective users or class of user.

12. The system of claim 2, comprising a computer system for dynamically transmitting email notifications to video uploader of video recordings of peer-reviews, links, donations, dynamic ranking, programming associated with said video recordings.

13. The system of claim 2, comprising a computational system resident on a system server programmed to (a) dynamically compare and track responses and non-responses to system requests of peer reviews of video recordings; (b) generate email reminders to peer reviewers who have not reviewed video recordings to review video recordings with links to said video recordings and (c) computational system for dynamically instituting matching of non-peer-reviewed video recordings with unique peer reviewers and (d) computational system for generating email to peer reviewers with links to said non-peer-reviewed video recordings stored in a video recording uploading, data transmitting and storage module resident on a system server to said peer reviewers with request for peer reviews of said video recordings.

14. The system of claim 2, in which video recordings stored in a video recording uploading, data transmitting and storage module resident on a system server are (a) viewed by
peer reviewers on web-based viewing channels and (b) reviews and inputs favorable or unfavorable keyword data and favorable or unfavorable numerical data associated with said video recording (c) transmits said data to a system server configured to receive and transmit said data and (d) computational engine that generates a scoring value of most favorable to least favorable for each peer reviewed video recording and (e) a computer system comprising a customizable computational engine that dynamically ranks and transmits said scoring value associated with said video recording and said peer-review according to quality parameters for peer-review and numeric references to a peer-review programming module resident on a computer server capable of receiving and transmitting such data.
